(19) United States
(12) Patent Application Publication
(10) Pub. No.: US 2024/0220817 A1
(43) Pub. Date: Jul. 4, 2024

(54) SYSTEM AND METHOD FOR SELF-SUPERVISED FEDERATED LEARNING FOR AUTOMOTIVE APPLICATIONS

(71) Applicant: WOVEN BY TOYOTA, INC., Tokyo (JP)

(72) Inventors: Yuki KAWANA, Tokyo (JP); Yusuke Yachide, Tokyo (JP); Takaaki Tagawa, Tokyo (JP); Koichiro Yamaguchi, Tokyo (JP); Daisuke Hashimoto, Tokyo (JP); Hiroyuki Aono, Tokyo (JP); Ryo Takahashi, Tokyo (JP)

(73) Assignee: WOVEN BY TOYOTA, INC., Tokyo (JP)

(21) Appl. No.: 18/148,710

(22) Filed: Dec. 30, 2022

(51) Int. Cl. G06N 3/098; G07C 5/00

(52) U.S. Cl. CPC G06N 3/098; G07C 5/008

(57) ABSTRACT

A method includes receiving, from one or more server computers through a communication network, an edge model and collecting sensor data acquired by a sensor on a vehicle. The method also includes identifying a first data item from among the collected sensor data when the first data item is determined to satisfy a criterion. The method further includes applying a transformation to the identified first data item to generate a second data item to form a training dataset containing the first data item, the second data item, and a signal representing the transformation between the first data item and the second data item. The method further includes training with respect to the edge model on the training dataset and transmitting first data representing the trained edge model to the one or more server computers though the communication network.

### BACKGROUND

### 1. Field

The disclosure relates generally to a system and method for providing neural network training in autonomous vehicle applications. Specifically, this disclosure relates to providing Federated Learning training to a neural network while maintaining safety and user privacy.

### 2. Description of Related Art

A neural network may be integrated into an application deployed on a multitude of distributed edge devices (e.g., processors or computing devices implemented in hospitals or cellular phones). One method of training such neural networks is Federated Learning (FL), which trains machine learning (ML) models using large amounts of data while ensuring a user's privacy.

To this end, FL techniques consist of a local training phase and a global aggregation phase. In the local training phase, each edge device trains its copy of the neural network with data sensed and used by the application. By performing the training on the edge device, the local data is not exposed or transmitted externally (such as to a remote coordinator or server), thereby ensuring privacy of the edge device user's data. Instead, only the local updates to the neural networks trained on the edge devices are transmitted to a coordinator, which aggregates the updates to generate a new global model. The global model can then be provided to other edge devices for use in the application.

It is critically important that machine learning (ML) models integrated into safety-critical applications, such as computer vision (CL) or other ML applications (e.g., autonomous driving control) in an autonomous vehicle, are trained with large amounts of data in order to ensure accuracy of inference and safety of use in real-world environments. While FL may be applied to these models, there are no reliable supervision signals (e.g., human annotations) for the training in vehicle contexts. As a result, accuracy of inferences may decrease when trained on local data in vehicles.

### SUMMARY

One or more example embodiments provide a system and method for proving driving information to non-driver users.

According to an aspect of the disclosure, a method, implemented by programmed one or more processors, may include: receiving, from one or more server computers through a communication network, an edge model; collecting sensor data acquired by a sensor on a vehicle; identifying a first data item from among the collected sensor data when the first data item is determined to satisfy a criterion; applying a transformation to the identified first data item to generate a second data item to form a training dataset containing the first data item, the second data item, and a signal representing the transformation between the first data item and the second data item; training with respect to the edge model on the training dataset; and transmitting first data representing the trained edge model to the one or more server computers though the communication network.

According to an aspect of the disclosure, a computing device may include a memory storing instructions and a processor configured to execute the instructions to: receive, from one or more server computers through a communication network, an edge model; collect sensor data acquired by a sensor on a vehicle; identify a first data item from among the collected sensor data when the first data item is determined to satisfy a criterion; apply a transformation to the identified first data item to generate a second data item to form a training dataset containing the first data item, the second data item, and a signal representing the transformation between the first data item and the second data item; train with respect to the edge model on the training dataset; and transmit first data representing the trained edge model to the one or more server computers though the communication network.

According to an aspect of the disclosure, a non-transitory computer-readable medium may store instructions, the instructions comprising: one or more instructions that, when executed by one or more processors of a device, cause the one or more processors to: receive, from one or more server computers through a communication network, an edge model; collect sensor data acquired by a sensor on a vehicle; identify a first data item from among the collected sensor data when the first data item is determined to satisfy a criterion; apply a transformation to the identified first data item to generate a second data item to form a training dataset containing the first data item, the second data item, and a signal representing the transformation between the first data item and the second data item; train with respect to the edge model on the training dataset; and transmit first data representing the trained edge model to the one or more server computers though the communication network.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of a system according to an embodiment;

FIG. 2 is a diagram of components of an autonomous vehicle of FIG. 1 according to an embodiment;

FIG. 3 is a diagram of data processing associated with training a neural network for a plurality of autonomous vehicles according to an embodiment;

FIG. 4 is a diagram of transformations involved with data processing associated with training a neural network for a single autonomous vehicle according to an embodiment

FIG. 5 is a diagram of data processing associated with training a neural network for a single autonomous vehicle according to an embodiment;

FIG. 6 is a flowchart for a method of training a neural network for a autonomous vehicles according to an embodiment.

### DETAILED DESCRIPTION

The following detailed description of example embodiments refers to the accompanying drawings. The same reference numbers in different drawings may identify the same or similar elements.

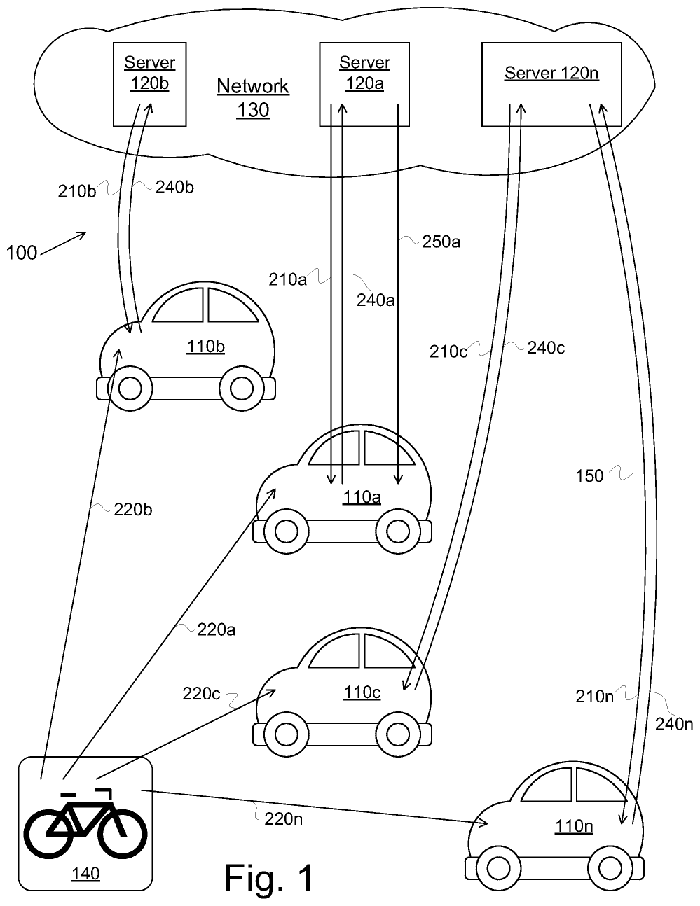

FIG. 1 is a diagram of a system 100 according to an embodiment. System 100 includes one or more vehicles 110a-n and one or more server computers 120a-n. The one or more server computers 120a-n may connect with each other and each of the vehicles 110a-n via, for example, a communications network 130.

Disclosed embodiments may involve receiving from one or more server computers 120. A server computer 120 as used in this disclosure may include a general purpose computer, a personal computer, a workstation, a mainframe computer, a notebook, a global positioning device, a laptop computer, a smart phone, a personal digital assistant, a network server, and any other electronic device that may interact with a user to develop programming code.

In some embodiments, the server computer 120 may include a processor, a display device, memory device, and other components including those components that facilitate electronic communication. Other components may include user interface devices such as an input and output devices. The server computer 120 may include computer hardware components such as a combination of Central Processing Units (CPUs) or processors, buses, memory devices, storage units, data processors, input devices, output devices, network interface devices, and other types of components that will become apparent to those skilled in the art. The server computer 120 may further include application programs that may include software modules, sequences of instructions, routines, data structures, display interfaces, and other types of structures that execute operations of the present disclosure.

Disclosed embodiments may involve receiving through a communication network 130. A communication network as used in this disclosure may include a set of computers (such as the one or more server computers 120) sharing resources located on or provided by network nodes. This set of computers may use common communication protocols over digital interconnections to communicate with each other. These interconnections may be made up of telecommunication network technologies, based on physically wired, optical, and wireless radio-frequency methods that may be arranged in a variety of network topologies. For example, these interconnections may take place through databases, servers, RF (radio frequency) signals, cellular technology, Ethernet, telephone, “TCP/IP” (transmission control protocol/internet protocol), and any other electronic communication format. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of servers 120 and networks 130 shown in FIG. 1 are provided as an example. In practice, there may be additional servers 120 and/or networks 130, fewer servers 120 and/or networks 130, different servers 120 and/or networks 130, or differently arranged servers 120 and/or networks 130 than those shown in FIG. 1. Furthermore, two or more servers 120 shown in FIG. 1 may be implemented within a single server 120, or a single server 120 shown in FIG. 1 may be implemented as multiple, distributed servers 130. Additionally, or alternatively, a set of servers 120 (e.g., one or more servers 120) may perform one or more functions described as being performed by another set of servers 120.

In some embodiments, the communications network 130 may be set up as a neural network. A neural network may be based on a collection of connected units or nodes called artificial neurons, which loosely model the neurons in a biological brain. Each connection, like the synapses in a biological brain, may transmit a signal to other neurons. An may artificial neuron receive signals to process and may then signal other neurons connected to it. These signals at a connection may be real numbers, and the output of each neuron may be computed by some non-linear function of the sum of its inputs. These connections may be edges (such as the autonomous vehicles 110). Neurons and edges may have a weight that adjusts as learning proceeds. The weight may increase or decrease the strength of the signal at a connection. Neurons may have a threshold such that a signal may be sent only if the aggregate signal crosses that threshold. Neurons may be aggregated into layers. Different layers may perform different transformations on their inputs. Signals may travel from a first layer (e.g., an input layer), to a last layer (e.g., an output layer), through potential intermediate layers and may do so multiple times.

As will be explained in further detail below, Federated Learning (FL) may be used to train neural networks of safety-critical automotive applications by incorporating reliable self-supervision to the local training performed on the edge devices. By applying FL, large amounts of data can be used to train the neural networks, thereby increasing the accuracy of inferences. Further, by applying FL, data privacy for a user (i.e., operator of a vehicle 110) can be ensured. Additionally, by incorporating a reliable self-supervision, the accuracy of inferences or predictions by the neural network can increase.

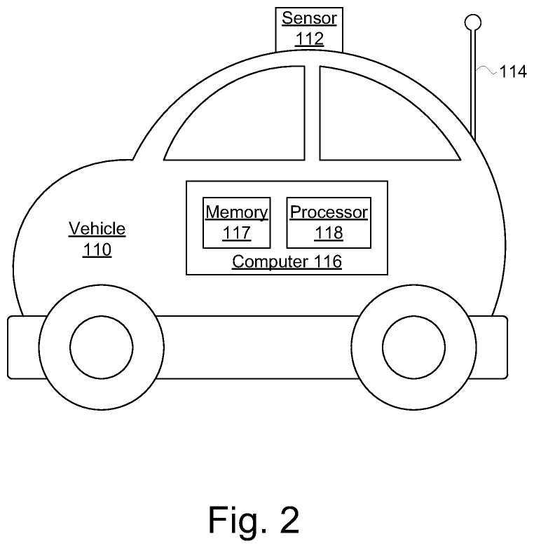

A more detailed view of a vehicle 110 may be seen in FIG. 2. Each of the vehicles 110 may include one or more sensors 112, one or more transceivers 114, and a vehicle computer 116.

The one or more transceivers 114 as used in this disclosure may include one or more components (e.g., a transceiver and/or a separate receiver and transmitter) that enables the vehicle 110 to communicate with other vehicles 110 and or the one or more server computers 120, such as via a wired connection, a wireless connection, or a combination of wired and wireless connections. The one or more transceivers 114 may permit vehicle 110 to receive information from another vehicle 110/server computer 120 and/or provide information to another vehicle 110/server computer 120. For example, the one or more transceivers 114 may include an Ethernet interface, an optical interface, a coaxial interface, an infrared interface, a radio frequency (RF) interface, a universal serial bus (USB) interface, a Wi-Fi interface, a cellular network interface, or any other interface capable of sending or receiving electric/electromagnetic information.

As seen in FIG. 2, the vehicle computer 116 as used in this disclosure may include a bus (not shown), a memory 117, a processor 118, an input component (not shown), and an output component (not shown).

The bus includes a component that permits communication among the components of the vehicle computer 116.

The processor 118 may be implemented in hardware, firmware, or a combination of hardware and software. The processor 118 may be at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 118 may include one or more processors capable of being programmed to perform a function.

The memory 117 includes a random access memory (RAM), a read only memory (ROM), and/or another type of dynamic or static storage device (e.g., a flash memory, a magnetic memory, and/or an optical memory) that stores information and/or instructions for use by the processor 118. The memory 117 may also store information and/or software related to the operation and use of the vehicle computer 116. For example, the memory 117 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component may include a component that permits the vehicle computer 116 to receive information, such as via user input (e.g., a touch screen display, a keyboard, a keypad, a mouse, a button, a switch, and/or a microphone). The input component may include a sensor for sensing information (e.g., a global positioning system (GPS) component, an accelerometer, a gyroscope, and/or an actuator).

The output component may include a component that provides output information from the vehicle computer 116 (e.g., a display, a speaker, and/or one or more light-emitting diodes (LEDs)).

The vehicle computer 116 may perform one or more processes described herein. The vehicle computer 116 may perform operations based on the processor 118 executing software instructions stored by a non-transitory computer-readable medium, such as the memory 117. A computer-readable medium is defined herein as a non-transitory memory device. A memory device includes memory space within a single physical storage device or memory space spread across multiple physical storage devices.

Software instructions may be read into the memory 117 from another computer-readable medium or from another device via the one or more transceivers 114. When executed, software instructions stored in the memory 117 may cause the processor 118 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

Disclosed embodiments may involve receiving an edge model 210 (such as edge model 210a). An edge model 210 as used in this disclosure may include machine learning models. The machine learning models may be configured to be integrated into applications running on an autonomous vehicle 110 (such as vehicle 110a). The applications running on an autonomous vehicle 110 may be safety-critical applications such as computer vision, autonomous driving control, and other machine learning applications associated with the operation of the autonomous vehicle 110. Autonomous driving control may include autonomous control of acceleration, braking, steering, transmission, and any other systems that may affect the movement of the vehicle 110 through its environment.

In some embodiments, the edge model 210 may be associated with detection of an object 140 that the vehicle 110 may encounter. The object may be another vehicle, a pedestrian, a wildlife animal, a road hazard, or any other aspect of the environment that could potentially interact with the vehicle 110. For example, in FIG. 1, the object 140 is depicted as bicycle on a roadway.

In some embodiments, the edge model 210 may be associated with sensory interpretation. For example, one type of sensory interpretation may include image segmentation. Image segmentation may partition a digital image into multiple image segments, (e.g., image regions or image objects (sets of pixels)). Image segmentation may simplify and/or change a representation of an image into something more meaningful and/or easier to analyze. Image segmentation is may be used to locate objects and boundaries (e.g., lines and curves) in images. Image segmentation may involve assigning a label to various pixels in an image such that pixels with the same label share certain characteristics.

As seen in FIGS. 1 and 2, the vehicle 110a may receive the edge model 210a via the one or more transceivers 114 and store the received edge model 210a, for example, in the memory 117 of the vehicle computer 116 of vehicle 110a. Similarly, other vehicles 110b-n may each receive a model (e.g., edge model 210b, edge model 210c, edge model 210n) similar to that of the edge model 210a at their respective transceivers 114 and store the respective received edge models 210b-n, for example, in the memory 117 of the vehicle computer 116 of the other vehicles 110b-n.

Disclosed embodiments may involve collecting sensor data 220a acquired by one or more sensors 112 in vehicle 110a. A sensor 112 as used in this disclosure may include cameras, camcorders, microphones, LiDAR, or any other devices configured collect sensor data 220a. Sensor data 220a as used in this disclosure may include photographs, video recording, sound recording, LiDAR data, or any other measurement recordings of the environment surrounding the vehicle 110a. Similarly, other vehicles 110b-n may each collect sensor data 220b-n via their respective sensors 112.

As seen in FIGS. 1 and 2, the vehicle 110a may receive the sensor data 220a via the one or more sensors 112 and store the received sensor data 220a, for example, in the memory 117 of the vehicle computer 116. Similarly, other vehicles 110b-n may each store their collected sensor data 220b-n via their respective memories 117 of their vehicle computers 116.

Disclosed embodiments may involve a vehicle 110 (such as vehicle 110a). A vehicle 110 as used in this disclosure may include a car, a van, a truck, a bus, a motorcycle, a moped, a drone, a robot, or any other locomotive device capable of complete or partial autonomous movement.

As seen in FIG. 1, system 100 may include multiple vehicles 110a-n. Each of the vehicles 110a-n may be substantially similar or different than any of the other vehicles 110a-n. In some embodiments, all of the vehicles 110a-n could be the same model autonomous car with similar sensory and motive capabilities/configurations. In other embodiments, all of the vehicles 110a-n could be different model autonomous vehicles with a variety of different sensory and motive capabilities/configurations. In other embodiments, some of the vehicles 110a-n could be of similar configurations while others could be of different configurations.

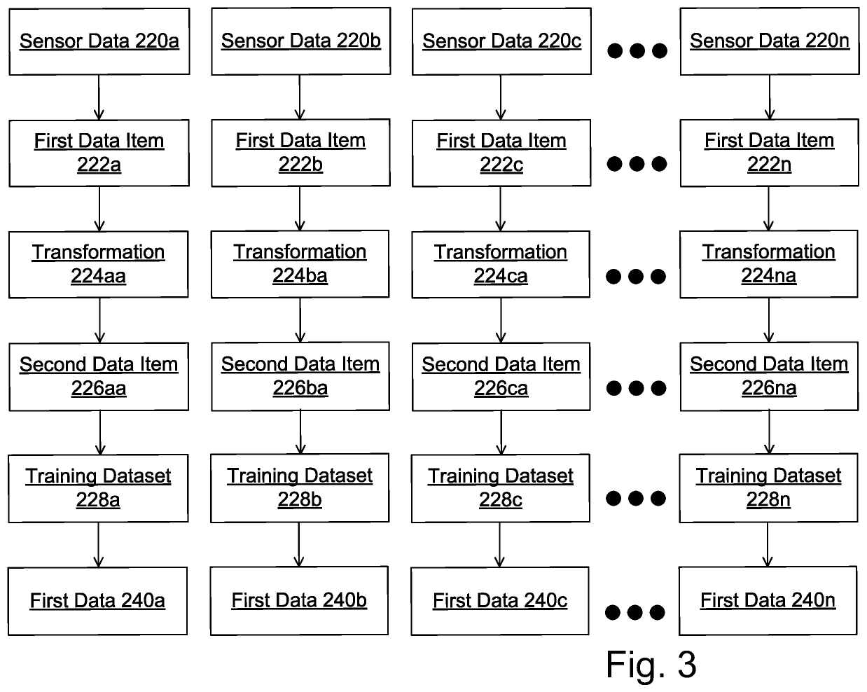

Disclosed embodiments may involve identifying a first data item 222a from among the collected sensor data 220a. A first data item 222a as used in this disclosure may include a subset of the sensor data 220a received by the vehicle 110a that may be useful for training the edge model 210a so as to improve accuracy of inference and safety of use in real-world environments. In a similar way, for example as seen in FIG. 3, the other vehicles 110b-n may involve identifying other first data items (e.g., first data item 222b, first data item 222c, first data item 222n) similar to that of the first data item 222a.

Disclosed embodiments may involve identifying when the first data item 222a is determined to satisfy a criterion. A criterion as used in this disclosure may include: (i) vehicle information (e.g., speed, steering, and braking) when the data is sensed (e.g., a speed that is greater than or equal to a predetermined speed, or a braking when the speed is greater than or equal to a predetermined speed, steering that is greater than or equal to a predetermined degree or amount, steering that is greater than or equal to a predetermined amount when the speed is greater than or equal to a predetermined speed, or any other conditions associated with vehicle movement useful for training the edge model 210); (ii) a position of the vehicle (e.g., as determined by inertial measurement unit (IMU), global positioning system (GPS), or any other sensors that may be used to determine relative or absolute location/orientation of the vehicle 110a) when the data is sensed; a time when the data is sensed; driver monitoring information when the data is sent; (iii) image recognition results (e.g., scene classification, variance of numbers of detected objects, road structure, or any other meaningful characteristics of the environment around the vehicle 110a); (iv) uniqueness/clustering of image features; (v) uncertainty metrics; (vi) and/or any other discernable characteristics indicative of being useful for training the edge model 210. In a similar way, other vehicles 110b-n may identify when their respective first data items 222b-n are determined to satisfy a criterion.

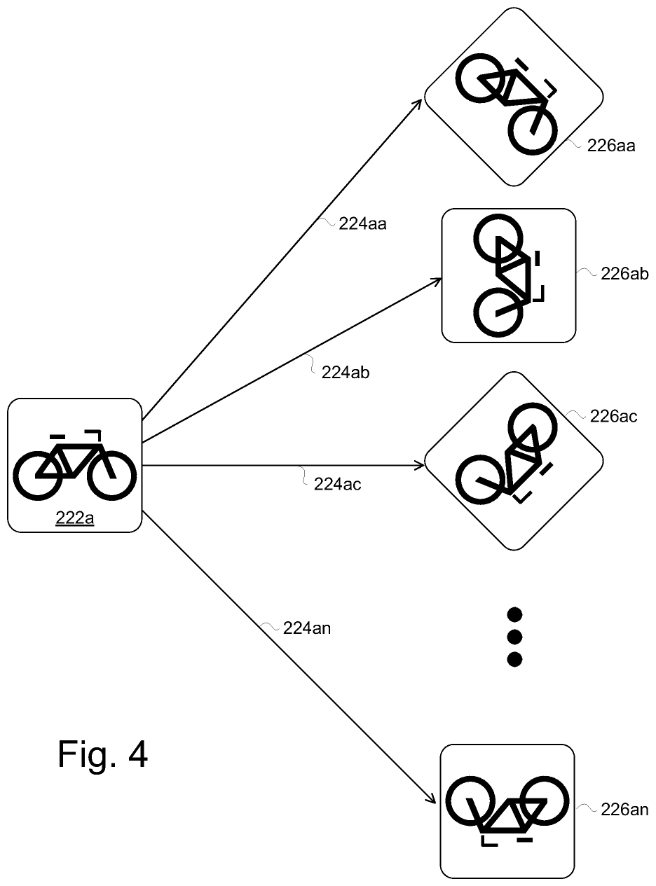

Disclosed embodiments may involve applying a transformation 224aa to the identified first data item 222a. A transformation 224aa as used in this disclosure may include rotation, inversion, contrast adjustments, or any other manipulation to the first data item 222a that may present the associated information in a different way. For example, as seen in FIG. 4, the first data item 222a may be an image of a bicycle and the transformation 224aa may be a rotation of the bicycle image by 45°. In some embodiments, additional transformations 224ab-an may be applied to the first data item 222a. For example, as seen in FIG. 4, transformation 224ab may be a rotation of the bicycle image by 90°, transformation 224ac may be a rotation of the bicycle image by 135°, and transformation 224an may be a rotation of the bicycle image by 180°. In a similar way, other vehicles 110b-n may apply their own transformations 224ba-nn to their respective first data items 222b-n.

In some embodiments (e.g., the above described examples), the transformation 224 (e.g., rotation) may be random so long as the transformation parameter (e.g., rotation amount) is stored and known by the trainer. By using training data in which the transformations are known, the neural network can be trained to recognize the rotation that is applied to the image that it gets as an input/trained without a supervision signal. A supervision signal as used in this disclosure may include a training example having an input and a desired output value.

Disclosed embodiments may involve applying a transformation 224aa to generate a second data item 226aa. A second data item 226aa as used in in this disclosure may include rotated data, inverted data, contrast adjusted data, or any other manipulated data transformed from the first data item 222a. For example, as seen in FIG. 4, the second data item 226aa may be an image of the bicycle that has been rotated by 45°. In some embodiments, additional data items 226ab-an may be generated by the applied transformations 224ab-an. For example, as seen in FIG. 4, third data item 226ab may be an image of the bicycle that has been rotated by 90°, fourth data item 226ac may be an image of the bicycle that has been rotated by 135°, and nth data item 226an may be an image of the bicycle that has been rotated by 180°. In a similar way, other vehicles 110b-n may generate their own second/additional data items 226ba-nn by applying the respective transformations 224ba-nn.

Additionally, it should be noted that while the additional transformations 224ab-an as depicted in FIG. 4 are all applied to the first data item 222a to generate the additional data items 226ab-an, this need not be the case. For example, in some embodiments the additional transformations 224ab-an may be applied to any of the generated second/additional data items 226aa-an instead of to the first data item 222a to generate the additional data items 226ab-an.

The edge model 210a may be run with the identified first data item 222a as input to the edge model 210a. In some embodiments, after (i) the edge model 210a has been received from the server computer 120 and stored in the memory 117 of the vehicle computer 116 of the vehicle 110a, and (ii) the first data item 222a has been stored in the memory 117 and identified by the processor 118 of the vehicle 110a, the processor 118 may input the first data item 222a into the edge model 210a to detect the object 140 as an inference. Running of the edge model 210a may result in detection of the object 140 and generate the inference with one or more particular confidence levels. These confidence levels may indicate a degree to which the edge model's 210a can accurately identify the object 140 in the real world environment. For example, the processor 118 may determine after running the first data item 222a through the edge model 210a that as an inference, there is 90% confidence, a bicycle has been detected. In a similar way, for example as seen in FIG. 3, the other vehicles 110b-n may run their respective received edge models 210b-n with their respective first data items 222b-n as inputs to generate inferences. The confidence intervals of these other inferences may individually be similar to, less than, or greater than the inference of the vehicle 110a.

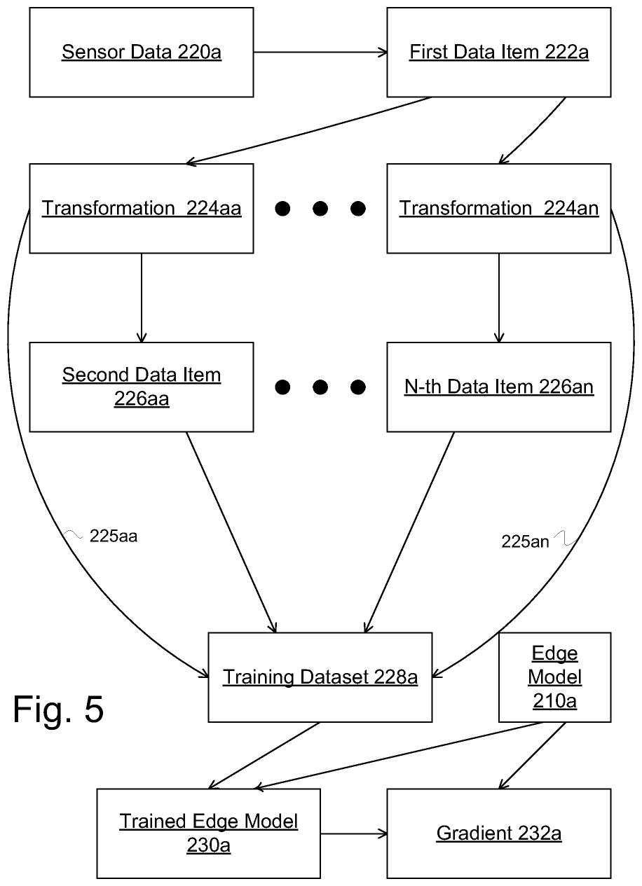

Disclosed embodiments may involve forming a training dataset 228a containing the first data item 222a, the second data item 226aa and a signal 225aa representing the transformation 224aa between the first data item 222a and the second data item 226aa (e.g., as seen in FIG. 5). Forming a training dataset 228a as used in this disclosure may include aggregating relevant information in a way that is useful for training a machine learning model. The training dataset 228a may include additional data items 226ab-nn (such as those shown in FIG. 4). Similarly, for example as seen in FIG. 3, the other vehicles 110b-n may generate their own training datasets (e.g., training dataset 228b, training dataset 228c, training dataset 228n) to include the respective first data item 222b-n, second/additional data items 226ba-nn, and signals 225ba-nn representing the transformations 224ba-nn between the first data item 222b-n and the second/additional data items 226ba-nn corresponding to the respective vehicles 110b-n.

Disclosed embodiments may involve training with respect to the edge model 210a on the training dataset 228a. Training as used in this disclosure may include a local training phase associated with FL. This training may be characterized as self-supervised training because the components of the training dataset 228a does not include any human annotated labels. A label as used in this disclosure is a meaningful or informative characteristic of an object (e.g., the object 140) that provides context so that a machine learning model can learn from it. For example, labels that may correspond to a bicycle may include two-wheeled, pedals, or handle bar. In some embodiments, the self-supervised training may be performed based on predetermined conditions being satisfied (e.g., the vehicle being parked, a WiFi connection being established, the vehicle being connected to an external power supply, a power supply being available, or any other conditions that would allow training to occur in a safe and efficient manner).

As seen in FIG. 4, training of the edge model 210a with the training dataset 228a may result in the generation of a trained edge model 230a. The trained edge model 230a may be capable of generating inferences at a higher confidence level than the untrained edge model 210a. For example, the processor 118 may determine after running the first data item 222a through the trained edge model 230a that as a trained first inference, there is 95% confidence (up from 90% using the original edge model 210a), a bicycle has been detected. Similarly, other vehicles 110b-n may train their respective edge models 210b-n on their respectively generated training datasets 228b-n to generate trained edge models 230b-n.

In some embodiments, the training with respect to the edge model 210a includes training a copy of the received edge model 210a. By training on a copy of the edge model 210a, the original edge model 210a may be preserved post training. Accordingly the performance of the original edge model 210a may be compared with that of the trained edge model 230a such that the model 210a, 230a capable of producing inferences with higher confidence levels may be used going forward. Similarly, other vehicles 110b-n may train their on a copy of their respective edge models 210b-n.

Disclosed embodiments may involve transmitting first data 240a representing the trained edge model 230a to the one or more server computers 120 though the communication network 130. By sending the first data 240a representing the trained edge model 230a (acquired by performing the training locally) as opposed to sending the training dataset 228a to the one or more servers 120 for training, a user's data privacy may be safeguarded. Similarly, as seen in FIG. 3, other vehicles 110b-n may generate their own first data (e.g., first data 240b, first data 240c, first data 240n) that may subsequently be transmitted to the one or more servers 120.

Disclosed embodiments may involve obtaining, as the first data 240a, a gradient 232a between the edge model 210a prior to the training and the edge model 230a subsequent to the training. A gradient 232a as used in this disclosure may include update parameters (e.g., weights) representing the differences between the edge model 210a and the trained edge model 230a. By sending only the gradient 232a and not the entirety of the updated/trained model 230a, a transmission overhead may be reduced thereby improving performance of the communication network 130. Similarly, other vehicles 110b-n may obtain, as their respective first data 240b-n, gradients 232b-n between their respective edge models 210b-n and trained edge models 230b-n that may subsequently be transmitted to the one or more servers 120.

Disclosed embodiments may involve receiving, from the one or more server computers 120 through a communication network 130, second data 250a that represents a model that is trained with aggregated model information from other edge models 230b-n. Second data 250a as used in this disclosure may include the result of a global aggregation phase associated with FL. For example, the one or more server computers 120 may aggregates the first data 240a-n (e.g., either the trained models 230a-n or the gradients 232a-n) received from each of plural edge vehicles 110a-n relative to the edge model 210a and updates the edge model 210a accordingly. The second data 250a may represent the updated edge model itself, or a gradient between the updated edge model and the original edge model 210a. Similarly, the other vehicles 110b-n may each respectively receive second data 250b-n. The second data 250b-n may represent an update to the respective models 210b-n based on an aggregation of the data 240a-n relative to the respective models 210b-n. The second data 250b-n may each be substantially the same or different from second data 250a. In some embodiments second data 250a is sent from the one or more server computers 120 to each of the edge vehicles 110a-n

Disclosed embodiments may involve updating the edge model 210a based on the second data 250a. After updating the edge model 210a (and potentially the trained edge model 230a if both copies are stored in the memory 117) with the second data 250a, the updated edge model may be capable of generating inferences at a higher confidence level relative to both the original edge model 210a and the trained edge model 230a. For example, the processor 118 may determine after running the first data item 222a through the updated edge model that as an updated first inference, there is 98% confidence (up from 95% using the trained edge model 230a and up from 90% using the original edge model 210a), a bicycle has been detected. Similarly, other vehicles 110b-n may update their respective edge models 210b-n respectively with second data 250b-n. Alternatively, the other vehicles 110b-n may update their respective edge models 210b-n with second data 250a.

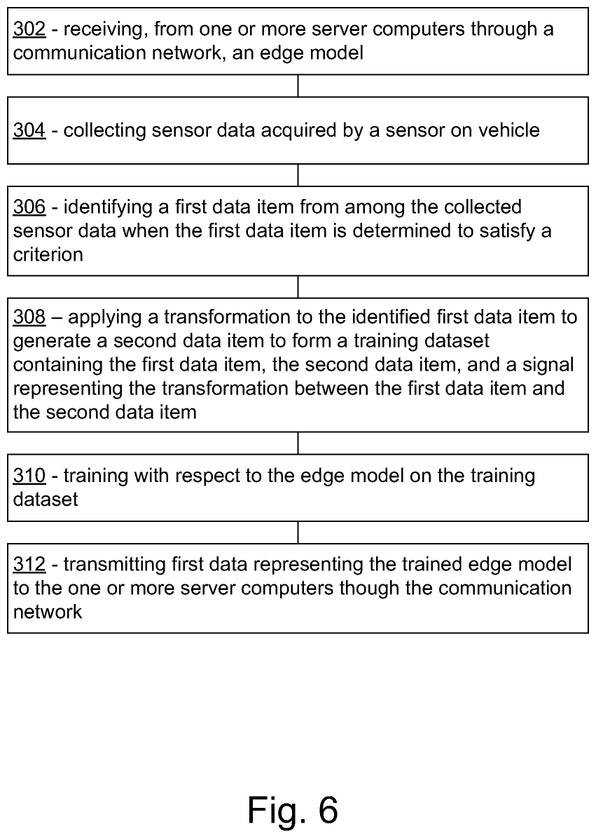

FIG. 6 is a flowchart for a method of providing FL training a neural network for autonomous driving vehicles according to an embodiment. Referring to FIG. 5, in operation 302, the system receives, from one or more server computers through a communication network, an edge model. In operation 304, the system collects sensor data acquired by a sensor on a vehicle. In operation 306, the system identifies a first data item from among the collected sensor data when the first data item is determined to satisfy a criterion. In operation 308, the system applies a transformation to the identified first data item to generate a second data item to form a training dataset containing the first data item, the second data item, and a signal representing the transformation between the first data item and the second data item. In operation 310, the system trains with respect to the edge model on the training dataset. In operation 312, the system transmits first data representing the trained edge model to the one or more server computers though the communication network.

It is understood that one or more operations of the above-described methods may be omitted or combined with other operations, and one or more additional operations may be added.

Utilizing the above described method, several advantages are achieved over conventional autonomous vehicle training techniques. By performing the training locally as opposed to sending the training data to the coordinator, a user's data privacy is ensured. By applying a reliable self-supervision, the training can be performed in a vehicle context in which supervision signals are not readily or practically attainable, and accuracy of inference can be improved. By sending only the gradient and not the updated/trained model, a transmission overhead is reduced thereby improving performance of the communication network. By aggregating updates to the ML model from plural edge devices, the ML model can be effectively trained with a large amount of data, thereby improving performance (accuracy of inference).

The foregoing disclosure provides illustration and description, but is not intended to be exhaustive or to limit the implementations to the precise form disclosed. Modifications and variations are possible in light of the above disclosure or may be acquired from practice of the implementations. For example, In some embodiments, at least some of the sensor data 220 may be annotated (e.g., by a user via a computing device). In this case, the sensor data 220 may be transmitted or provided to a smartphone, mobile device, or other computing device of a user, and the user can annotate objects in the image. In other embodiments, after the self-supervised training (e.g., prediction of rotation), supervised training using human-annotated labels may be applied. Training a neural network with such initial self-supervision boosts performance in successive supervised learning. For prediction of rotation angles, a neural network may require an understanding of the direction of objects in an image. Accordingly, the neural network may learn to focus on specific image features. For example, in an image with a front-faced car in it, to tell whether a car is upside down in an image, it may be important to understand that a license plate usually is located below the front shield. Thus; if the front shield is located above the license plate, then it's likely the car in the image is upside-down. A neural network may not initially know the image features it extracts called “license plate” or “front shield”. Accordingly, general self-supervised training induces a neural network to learn to extract useful image features, rather than simple geometry like lines or edges. In a second stage, when supervised training is applied after self-supervised learning, a neural network may be taught how to use the learned image feature to predict certain objects. In general, how many useful image features a neural network can extract correlates to the higher performance and better extraction generally correlates to the number of images a neural network is exposed during the training. Therefore, using more images by self-supervised learning helps to boost performance rather than training only on a smaller number of images with human-labeled annotation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

What is claimed is:

1. A method, implemented by programmed one or more processors, comprising:
receiving, from one or more server computers through a communication network, an edge model;
collecting sensor data acquired by a sensor on a vehicle;
identifying a first data item from among the collected sensor data when the first data item is determined to satisfy a criterion;
applying a transformation to the identified first data item to generate a second data item to form a training dataset containing the first data item, the second data item, and a signal representing the transformation between the first data item and the second data item;
training with respect to the edge model on the training dataset; and
transmitting first data representing the trained edge model to the one or more server computers though the communication network.

2. The method according to claim 1, further comprising:
receiving, from the one or more server computers through the communication network, second data that represents a model that is trained with aggregated model information from other edge models; and
updating the edge model based on the second data.

3. The method according to claim 1, wherein the training with respect to the edge model comprises training a copy of the received edge model.

4. The method according to claim 1, further comprising obtaining, as the first data, a gradient between the edge model prior to the training and the edge model subsequent to the training.

5. The method according to claim 3, further comprising obtaining, as the first data, a gradient between the received edge model and the copy of the edge model that is updated by the training.

6. The method according to claim 1, wherein the applying the transformation comprises rotating the first data item.

7. The method according to claim 1, wherein the training on the training dataset comprises training without human annotation.

8. A computing device, comprising:
a memory storing instructions; and
a processor configured to execute the instructions to:
receive, from one or more server computers through a communication network, an edge model;
collect sensor data acquired by a sensor on a vehicle;
identify a first data item from among the collected sensor data when the first data item is determined to satisfy a criterion;
apply a transformation to the identified first data item to generate a second data item to form a training dataset containing the first data item, the second data item, and a signal representing the transformation between the first data item and the second data item;
train with respect to the edge model on the training dataset; and
transmit first data representing the trained edge model to the one or more server computers though the communication network.

9. The computing device according to claim 8, wherein the processor is further configured to execute the instructions to:
receive, from the one or more server computers through the communication network, second data that represents a model that is trained with aggregated model information from other edge models; and
update the edge model based on the second data.

10. The computing device according to claim 8, wherein the instructions to train with respect to the edge model comprises instructions to train a copy of the received edge model.

11. The computing device according to claim 8, wherein the processor is further configured to execute the instructions to obtain, as the first data, a gradient between the edge model prior to the training and the edge model subsequent to the training.

12. The computing device according to claim 10, wherein the processor is further configured to execute the instructions to obtain, as the first data, a gradient between the received edge model and the copy of the edge model that is updated by the training.

13. The computing device according to claim 8, wherein the instructions to apply the transformation comprises instructions to rotate the first data item.

14. The computing device according to claim 8, wherein the instructions to train on the training dataset comprises instructions to train without human annotation.

15. A non-transitory computer-readable medium storing instructions, the instructions comprising: one or more instructions that, when executed by one or more processors of a device, cause the one or more processors to:
receive, from one or more server computers through a communication network, an model;
collect sensor data acquired by a sensor on a vehicle;
identify a first data item from among the collected sensor data when the first data item is determined to satisfy a criterion;
apply a transformation to the identified first data item to generate a second data item to form a training dataset containing the first data item, the second data item, and a signal representing the transformation between the first data item and the second data item;
train with respect to the edge model on the training dataset; and
transmit first data representing the trained edge model to the one or more server computers though the communication network.

16. The non-transitory computer-readable medium of claim 15, wherein the instructions further comprise: one or more instructions that, when executed by one or more processors of a device, cause the one or more processors to:
receive, from the one or more server computers through the communication network, second data that represents a model that is trained with aggregated model information from other edge models; and
update the edge model based on the second data.

17. The non-transitory computer-readable medium of claim 15, wherein causing the one or more processors to train with respect to the edge model comprises causing the one or more processors to train a copy of the received edge model.

18. The non-transitory computer-readable medium of claim 15, wherein the instructions further comprise: one or more instructions that, when executed by one or more processors of a device, cause the one or more processors to obtain, as the first data, a gradient between the edge model prior to the training and the edge model subsequent to the training.

19. The non-transitory computer-readable medium of claim 17, wherein the instructions further comprise: one or more instructions that, when executed by one or more processors of a device, cause the one or more processors to obtain, as the first data, a gradient between the received edge model and the copy of the edge model that is updated by the training.

20. The non-transitory computer-readable medium of claim 15, wherein causing the one or more processors to apply the transformation comprises causing the one or more processors to rotate the first data item.
